(19) United States
(12) Patent Application Publication
(10) Pub. No.: US 2025/0019785 A1
(43) Pub. Date: Jan. 16, 2025

(54) HIGH-ALUMINUM BORON-CONTAINING DIE STEEL WITH RESISTANCE TO ZINC-INDUCED HOT CORROSION FOR SEVERE PLASTIC DEFORMATION OF ZINC ALLOYS AT ELEVATED TEMPERATURE AND PREPARATION METHOD THEREOF

(71) Applicant: XI'AN JIAOTONG UNIVERSITY, Xi'an (CN)

(72) Inventors: Shengqiang MA, Xi'an (CN); Ping LV, Xi'an (CN); Yusheng LIU, Xi'an (CN); Zhiduo LIU, Xi'an (CN); Jiandong XING, Xi'an (CN); Yang LUO, Xi'an (CN); Yongqi SONG, Xi'an (CN); Xiaonan WANG, Xi'an (CN); Kai HU, Xi'an (CN)

(21) Appl. No.: 18/900,843

(22) Filed: Sep. 29, 2024

(30) Foreign Application Priority Data
Jan. 12, 2024 (CN) 202410050702.4

(51) Int. Cl. C21D 9/00; C21D 1/18; C21D 1/84; C21D 6/00; C21D 8/00; C22C 38/02; C22C 38/06; C22C 38/22; C22C 38/24; C22C 38/28; C22C 38/32

(52) U.S. Cl. CPC C21D 9/0068; C21D 1/18; C21D 1/84; C21D 6/002; C21D 6/008; C21D 8/005; C22C 38/02; C22C 38/06; C22C 38/22; C22C 38/24; C22C 38/28; C22C 38/32

(57) ABSTRACT

A method of preparing a high-aluminum boron-containing die steel for severe plastic deformation of zinc alloys at elevated temperature, in which a cast ingot is obtained by sand casting, and then subjected to homogenization, austenitization, hot-die forging and cooling to obtain a heat-treated piece. The heat-treated piece is quenched and tempered to obtain a forged piece, which is subjected to finish machining to obtain the high-aluminum boron-containing die steel. A high-aluminum boron-containing die steel prepared by such method is further provided.

### CROSS-REFERENCE TO RELATED APPLICATIONS

This application claims the benefit of priority from Chinese Patent Application No. 202410050702.4, filed on Jan. 12, 2024. The content of the aforementioned application, including any intervening amendments thereto, is incorporated herein by reference in its entirety.

### TECHNICAL FIELD

This application relates to a tool steel for severe plastic deformation of die-forming zinc alloys at elevated temperature, and more particularly to a high-aluminum boron-containing die steel with resistance to zinc-induced hot corrosion for severe plastic deformation of zinc alloys as die forming at elevated temperature, and a preparation method thereof.

### BACKGROUND

With the continuous development of industrial technology, higher and higher requirements have been raised for material properties, and the strength and plasticity of the as-cast zinc alloys no longer meet the requirements of various industrial applications. Severe plastic deformation, as an ultra-grain processing technique, has been widely used as one of the strengthening and toughening methods for the zinc alloys. Commonly, the severe plastic deformation is achieved by mechanically restricting the zinc alloy with a mold at high temperatures through shear deformation process, where the mold greatly suffers harsh zinc hot corrosion during severe plastic deformation, to be solved for the rigorous zinc hot corrosion issue in the hot forming mold of zinc alloys. Here, the severe plastic deformation method can significantly improve the strength and plasticity of zinc alloy. Moreover, the zinc alloy die-casting mold and the zinc ingot mold for zinc ingot production are also both required to repeatedly undergo the molten zinc-induced erosion, hot corrosion and thermal fatigue, and thus the demands for mold materials (i.e., die mold or die steel) with resistance to the more rigorous molten zinc-induced erosion or zinc hot corrosion is likewise increasingly growing and necessarily explored.

According to the present use condition, the die steel involved in the thermal plastic deformation process belongs to the hot-extrusion die steel in the hot-working die steel. Common hot-extrusion die steel is mainly divided into two categories: medium-heat-resistant die steel with use temperature of 550-600° C., such as 4Cr5MoSiV (H13), 4Cr5MoSiV1, and 4Cr5W2SiV; and high-heat-resistant die steel with use temperature of 580-650° C., such as 3Cr2W8V, 3Cr3Mo3W2V, and 4Cr3Mo3SiV. The 4Cr5MoSiV (H13) steel is widely recognized as one of the most ideal materials for preparing die-casting and hot-deformation molds of aluminum, copper and zinc and their alloys thereof, and is also commonly used in the preparation of die steels for the severe plastic deformation of zinc alloys. However, this material as a mold has high cost and complex processing duration, and is prone to frequent fracture, thermal fatigue and spalling during the hot-extrusion process of zinc alloys with a strong thermal erosion and corrosion, resulting in an obvious shortened service life. On one hand, given the extremely harsh service conditions, such as strong working stress and impact load, repeated heating and cooling, and metal impact and friction, the hot-working die is prone to premature failure. On the other hand, compared with other common non-ferrous metal alloys, such as copper alloys and aluminum alloys, zinc alloy has lower melting point, higher viscosity, and stronger adhesion, and thus is easy to form an adhesion on the mold surface to thermally corrode the mold. Under the action of high-temperature mechanical effects, the adhesion will further form hardened erosive deposits (namely, hot melting erosion), significantly reducing the service life of the mold. Thus, the above reasons greatly limit the service life of the mold used for severe plastic processing of zinc alloy at elevated temperatures, which will result in high processing cost of zinc alloys, thereby hindering the large-scale application of zinc alloy. Therefore, there is an urgent need to develop a new die steel to solve this problem for zinc alloy forming process.

Specifically, the die steel used for severe plastic deformation of zinc alloys faces the following severe working conditions. Firstly, since the zinc alloy with the hexagonal structure is difficult to produce severe plastic deformation, die steel needs to work under high load, which requires good strength and wear resistance. At the same time, the severe plastic deformation of zinc alloy is often carried out at high temperatures, so the die steel not only need to have a certain degree of oxidation resistance, but also need to have a certain degree of resistance to zinc melting corrosion and high temperature endurance strength. The main reason for hot melting corrosion phenomenon of the die steel is that the zinc alloy is easy to adhere and penetrate to iron-based alloys, resulting in serious melting corrosion. In the hot extrusion of zinc alloy, the mold surface closely contacts the zinc alloy in the high temperature state, inducing hot melting corrosion phenomenon, which results in embrittlement, cracking and melting pits or severe scabs of the mold surface. In addition, the die steel used for high temperature extrusion of zinc alloy is prone to severe thermal fatigue failure due to the presence of corrosive media, stress condition, and repeated thermal fatigue at high temperature in the working environment, the stress corrosion and thermal spalling phenomenon occur sometimes, and the mold is easy to premature failure. In short, considering the harsh service conditions of the severe plastic deformation of zinc alloys, strict requirements are put forward for composition design and processing method of the die steel.

### SUMMARY

In view of the deficiencies in the prior art, this application provides a high-aluminum boron-containing die steel with resistance to zinc-induced hot corrosion for severe plastic deformation of zinc alloys at elevated temperature and a preparation method thereof, which solves serious zinc-induced hot corrosion, serious fatigue failure, and short service life of the die steel used for severe plastic deformation of zinc alloys, and spalling and cracking, high cost, high-temperature abrasion, and short service life of the extrusion die of zinc alloys.

Technical solutions of this application are described as follows.

In a first aspect, this application provides a method of preparing an aluminum- and boron-containing die steel for severe plastic deformation of zinc alloys, comprising:
(S1) preparing a cast aluminum- and boron-containing die steel ingot through sand casting;
(S2) subjecting the cast aluminum- and boron-containing die steel ingot to homogenization, austenitization, hot-die forging and cooling processes to obtain a heat-treated piece;
(S3) subjecting the heat-treated piece to quenching and tempering treatments to obtain a forged piece; and
(S4) performing finish machining on the forged piece to obtain the aluminum- and boron-containing die steel.

In an embodiment, in step (S1), the sand casting comprises a melting step at 1550-1600° C. and a pouring step at 1440-1480° C.

In an embodiment, the cast ingot is cylindrical.

In an embodiment, in step (S2), the hot-die forging is performed at a temperature of 980-1100° C., a forging ratio of 6-8 and a strain rate of 0.01-4 s⁻¹.

In an embodiment, in step (S2), the homogenization is performed at 1020-1080° C. for 3-5 h.

In an embodiment, in step (S2), the cooling is performed by air cooling.

In an embodiment, in step (S3), the quenching is performed at 1040-1080° C. for 1.5-2 h; and the tempering is performed at 480-530° C. for of 2.5-4.0 h.

In an embodiment, a quenching medium is oil; and after the tempering, the forged piece is cooled to room temperature by furnace cooling.

In an embodiment, in step (S4), the aluminum- and boron-containing die steel has a truncated cone structure with a taper of 9-11°.

In a second aspect, this application provides an aluminum- and boron-containing die steel prepared by the method above, in weight percentage, comprising: C: 0.15%-0.25%; B: 1.4%-1.8%; W: 1.4%-1.6%; V: 1.1%-1.3%; Mo: 1.55%-1.75%; Cr: 5.0%-5.5%; Ti: 0.6%-0.8%; Si: 0.4%-1.3%; Al: 2.4%-5.8%; and Fe: balance.

Compared to the prior art, this application has the following beneficial effects.

In the method of preparing an aluminum- and boron-containing die steel with resistance to zinc-induced hot corrosion for severe plastic deformation of zinc alloys, the cast ingot is prepared by sand casting, and then the cast ingot is forged to obtain the die steel with excellent strength and toughness. By alloying B, W, Mo, V, Cr, Ti, Si, and Al elements and performing subsequent heat treatment, the strength, toughness, stress corrosion resistance of zinc alloy hot corrosion, and high temperature abrasion resistance of the die steel are improved.

In step S1, the pouring temperature is arranged for the molten metal liquid with a good sand mold-filling capacity, which helps to obtain the cast ingot with a complete shape and clear contour.

After the cast ingot is subjected to homogenization at 1020-1080° C. for 3-5 h, the cast ingot is subjected to hot-die forging at a temperature of 980-1100° C., a forging ratio of 6-8 and a strain rate of 0.01-4 s⁻¹. The hot-die forging is followed by cooling in air. These steps result in significant fragmentation and refinement of the original fishbone-like boride-reinforced phase in the matrix. As a result, the toughness of the high aluminum boron-containing die steel is improved.

In step S2, the homogenizing heat preservation treatment at 1020-1080° C. for 3-5 h is carried out before forging. These steps make the ingot composition more homogeneous, eliminate dendritic segregation, and obtain the desired microstructures of the high-temperature austenitic matrix and the boride-reinforced phases, which increases the thermal plastic deformation capacity during forging for the smooth progress of the forging process.

In step S3, the quenching is performed at 1040-1080° C. for 1.5-2 h, and oil is used as medium. After the quenching, the high-temperature tempering is performed at 480-530° C. for 2.5-4.0 h, and the tempered forged piece is cooled to room temperature by cooling in the furnace. Quenching treatment makes the matrix microstructure of the die steel transform into martensite and ferrite. The martensite matrix has excellent strength hardness, while the broken borides after forged are further isolated and spheroidized. Tempering fully reduces the residual stresses generated during the quenching process and achieves dispersive strengthening precipitation phase to enhance the toughness and high temperature wear resistance of the die.

In the aluminum- and boron-containing die steel with resistance to molten zinc-induced erosion for severe plastic deformation of zinc alloys, boron element is added to improve the hardenability of the die and produce Fe₂B or M₂B-type boride, so that there is unique boride phase with excellent strength and hardness in microstructures; Al element is added to enhance antioxidant properties and resistance to molten zinc-induced erosion ability of the die; Si element is added to slow down high temperature oxidation process of the die to enhance the antioxidant properties; and Cr element is introduced into the steel to improve the resistance to molten zinc-induced erosion ability and anti-oxidation ability of the die.

In summary, the high-aluminum boron-containing die steel with resistance to molten zinc-induced erosion can be more adaptable to the harsh working conditions, which provides a new way for designing and manufacturing severe plastic deformation die of non-ferrous alloys such as zinc alloy.

The technical solution of this application will be further described in detail below by the accompanying drawings and embodiments.

### BRIEF DESCRIPTION OF THE DRAWINGS

FIG. 1 is a scanning electron microscope (SEM) image of a high-aluminum boron-containing die steel prepared in Embodiment 1 of the present disclosure;

FIG. 2 is a flow chart of a preparation process of the high-aluminum boron-containing die steel according to one embodiment of the present disclosure;

FIG. 3 is a photograph of a truncated cone-shaped liner of the high-aluminum boron-containing die steel;

FIG. 4a is a photograph showing a liner of a H13 die steel after being used 20 times; and

FIG. 4b is a photograph of a liner of the high-aluminum boron-containing die steel after being used 20 times.

### DETAILED DESCRIPTION OF EMBODIMENTS

The technical solutions of the disclosure will be described clearly and completely below. Obviously, described below are merely some embodiments of the present disclosure, which are not intended to limit the disclosure. For those skilled in the art, other embodiments obtained based on these embodiments without paying creative efforts should fall within the scope of the disclosure.

In the disclosure, unless otherwise expressly specified, individual embodiments involved herein as well as the preferred implementation methods can be combined with each other to form new technical solutions.

In the disclosure, unless otherwise expressly specified, all technical features involved herein as well as preferred features can be combined with each other to form new technical solutions.

In the disclosure, unless otherwise expressly specified, the percentage (%) or part refers to the weight percentage relative to the composition or weight part.

In the disclosure, unless otherwise expressly specified, the components involved herein, or preferred components may be combined with each other to form new technical solutions.

In the disclosure, unless otherwise expressly specified, the value range “a-b” denotes an abbreviated form of any combination of real numbers between a and b, where both a and b are real numbers. For example, the value range “6-22” means that all real numbers between “6-22” have been listed herein, and “6-22” is only an abbreviated representation of the combination of these values.

The “range” disclosed herein may be one or more lower limits and one or more upper limits in the form of lower and upper limits, respectively.

In the disclosure, the term “and/or” as used herein refers to any combination and all possible combinations of one or more of the listed items.

In the disclosure, unless expressly specified otherwise, the individual reactions or steps may be performed sequentially. Preferably, the reaction methods herein are performed sequentially.

Unless otherwise expressly specified, technical terms used herein have the same meaning as those familiar to those skilled in the art. In addition, any method or material similar or equivalent to what is documented in this disclosure may also be applied in the disclosure.

Provided herein are the high-aluminum and boron-containing die steel with resistance to molten zinc-induce erosion for severe plastic deformation of zinc alloys and its preparation method. In the manufacturing process, the morphology and microstructure of borides are modified by composition adjustment, forging and heat treatment to offer reinforcing effects such as work hardening and precipitation strengthening, so as to obtain the high-aluminum boron-containing die steel with excellent high-temperature toughness, excellent stress corrosion resistance, and excellent thermal fatigue performance. The die steel provided herein has excellent mechanical properties, and thus can be used as an excellent alternative material to the H13 hot-working die steel.

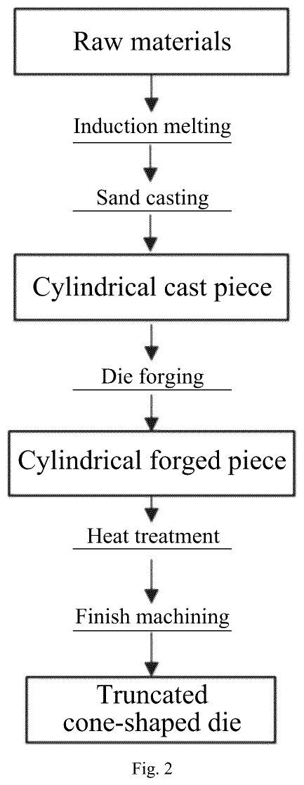

The method provided herein for preparing the high-aluminum and boron-containing die steel will be described with reference to FIG. 2.
(S1) A cylindrical cast aluminum- and boron-containing die steel ingot is prepared by sand casting.

The alloy is melted in a high frequency induction furnace, and the cylindrical cast ingot is prepared through the sand casting including a melting step at 1550-1600° C. and a pouring step at 1440-1480° C.
(S2) The cylindrical cast ingot is subjected to hot-die forging to obtain a heat-treated piece.

The cylindrical cast ingot is successively subjected to annealing treatment, hot-die forging and air cooling.

The homogenization treatment before hot-die forging is performed at 1020-1080° C. for 3-5 h. The hot-die forging is performed at a temperature of 980-1100° C., a forging ratio of 6-8, and a strain rate of 0.01-4s⁻¹. The cooling is performed by air cooling.
(S3) The heat-treated piece is subjected to quenching and tempering under high temperature to obtain a forged piece.

The quenching treatment is performed at a temperature of 1040-1080° C. and a quenching medium of oil for 1.5-2 h. The tempering treatment is performed at 480-530° C. for 2.5-4.0 h. After tempering, the forged piece is cooled to the room temperature by furnace cooling.
(S4) The forged piece is subjected to finishing machining to obtain a die liner having a truncated cone structure.

The forged piece is subjected to finish machining to obtain the aluminum and boron-containing die steel having a truncated cone structure with a taper of 9-11°.

The aluminum and boron-containing die steel prepared by the method above, in the weight percentage, includes C: 0.15%-0.25%, B: 1.4%-1.8%, W: 1.4%-1.6%, V: 1.1%-1.3%, Mo: 1.55%-1.75%, Cr: 5.0%-5.5%, Ti: 0.6%-0.8%, Si: 0.4%-1.3%, Al: 2.4%-5.8%, and Fe: balance.

The high-aluminum boron-containing die steel prepared by the method of the disclosure is low-cost, and has a dense microstructure. After being tempered, the high-aluminum boron-containing die steel has the secondary precipitation phase with a high degree of dispersion, the alloy's density is reduced, and the density of intracrystalline dislocations is high. The high-aluminum boron-containing die steel has high strength and toughness, and high-temperature wear-resistant. The lightweight manufacturing is achieved in the disclosure.

The present disclosure will be further described in detail below in conjunction with the accompanying drawings and embodiments to understand the objects, technical solutions, and advantages of the present disclosure more clearly. Obviously, described below are merely some embodiments of the disclosure, which are not intended to limit the disclosure. It should be noted that the components in the embodiments and the drawings herein may be arranged and designed in different forms. Accordingly, the following detailed description is merely illustrative, and not intended to limit the scope of the disclosure. For those skilled in the art, other embodiments obtained based on these embodiments without paying creative efforts should fall within the scope of the disclosure defined by the appended claims.

### Embodiment 1

Provided herein was a method of preparing an aluminum- and boron-containing die steel with resistance to zinc-induced hot corrosion for severe plastic deformation of zinc alloys.

(1) The raw material, including, in weight percentage, 0.15% C, 1.4% B, 1.4% W, 1.1% V, 1.55% Mo, 5.0% Cr, 0.6% Ti, 0.4% Si, 2.4% Al, and Fe for balance, was melted to 1550° C., and subjected to sand casting to obtain a cylindrical cast ingot, where a pouring temperature of the sand casting was 1440° C. The cylindrical cast ingot was cooled to room temperature by air cooling.

(2) The cast ingot was homogenized at 1020° C. for 3 h, hot-die forged at a temperature of 980° C., a forging ratio of 6 and a strain rate of 0.01 s⁻¹, and then cooled to room temperature by air cooling to obtain a heat-treated piece.

(3) The heat-treated piece was quenched at 1040° C. for 1.5 h, tempered at 480° C. for 2.5 h and cooled to room temperature inside the furnace to obtain a forged piece, where oil was used as the quenching medium.

(4) The forged piece was subjected to finish machining to obtain a truncated cone-shaped die liner with a taper of 9°.

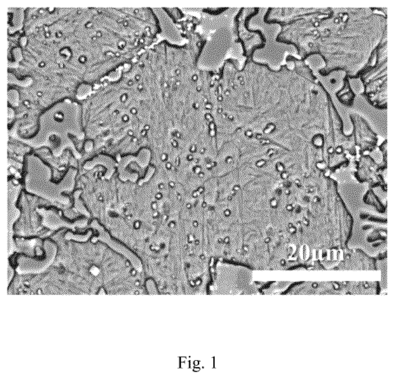

The forged piece was microstructurally observed under a scanning electron microscope (SEM). As shown in FIG. 1, the boride in the microstructure was significantly refined and distributed in the martensite-ferrite mixed matrix in a broken state, and the boride partially underwent spheroidization. The boride in the high-aluminum boron-containing die steel had a continuous network or fishbone morphology, which was not conducive to the toughness and fatigue resistance of the alloy. Through the forging process, the fishbone-like boride reinforced phase in the alloy was significantly broken and refined, and after the quenching and tempering process, the sharp structure of the boride was further spheroidized, thereby improving toughness of the high-aluminum boron-containing die steel.

### Embodiment 2

Provided herein was a method of preparing an aluminum- and boron-containing die steel with resistance to zinc-induced hot corrosion for severe plastic deformation of zinc alloys.

(1) The raw material, including, in weight percentage, 0.25% C, 1.8% B, 1.6% W, 1.3% V, 1.75% Mo, 5.5% Cr, 0.8% Ti, 1.3% Si, 5.8% Al, and Fe for balance, was melted to 1600° C., and subjected to sand casting to obtain a cylindrical cast ingot, where a pouring temperature of the sand casting was 1480° C. The cylindrical cast ingot was cooled to room temperature by air cooling.

(2) The cast ingot was homogenized at 1080° C. for 5 h, hot-die forged at a temperature of 1100° C., a forging ratio of 8, and a strain rate of 4 s⁻¹, and then cooled to room temperature by air cooling to obtain a heat-treated piece.

(3) The heat-treated piece was quenched at 1080° C. for 2 h, tempered at 530° C. for 4 h and cooled to room temperature inside the furnace to obtain a forged piece, where oil was used as the quenching medium.

(4) The forged piece was subjected to finishing machining to obtain a truncated cone-shaped die liner with a taper of 11°.

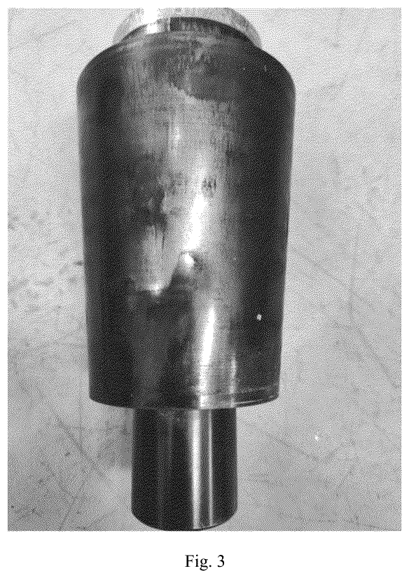

Photograph of the obtained truncated cone-shaped liner of the high-aluminum boron-containing die steel was shown in FIG. 3.

### Embodiment 3

Provided herein was a method of preparing an aluminum- and boron-containing die steel with resistance to zinc-induced hot corrosion for severe plastic deformation of zinc alloys.

(1) The raw material, including, in weight percentage, 0.25% C, 1.6% B, 1.6% W, 1.3% V, 1.75% Mo, 5.5% Cr, 0.7% Ti, 1.2% Si, 3.8% Al, and Fe for balance, was melted to 1560° C. and subjected to sand casting to obtain a cylindrical cast ingot, where a pouring temperature of the sand casting was 1460° C. The cylindrical cast ingot was cooled to room temperature by air cooling.

(2) The cast ingot was homogenized at 1050° C. for 4 h, hot-die forged at a temperature of 1000° C., a forging ratio of 8 and a strain rate of 0.05 s⁻¹, and cooled to room temperature by air cooling to obtain a heat-treated piece.

(3) The heat-treated piece was quenched at 1050° C. for 1.5 h, tempered at 500° C. for 3 h and cooled to room temperature inside the furnace to obtain a forged piece, where the oil was used as the quenching medium.

(4) The forged piece was subjected to finishing machining to obtain a truncated cone-shaped die liner with a taper of 10°.

### Embodiment 4

Provided herein was a method of preparing an aluminum- and boron-containing die steel with resistance to zinc-induced hot corrosion for severe plastic deformation of zinc alloys.

(1) The raw material, including, in weight percentage, 0.2% C, 1.5% B, 1.5% W, 1.2% V, 1.65% Mo, 5.2% Cr, 0.7% Ti, 1.0% Si, 2.6% Al, and Fe for balance, was melted to 1560° C. and subjected to sand casting to obtain a cylindrical cast ingot, where a pouring temperature of the sand casting was 1460° C. The cylindrical cast ingot was cooled to room temperature by air cooling.

(2) The cast ingot was homogenized at 1060° C. for 4 h, hot-die forged at a temperature of 1100° C. with a forging ratio of 6 and a strain rate of 0.04 s⁻¹, and cooled to room temperature by air cooling to obtain a heat-treated piece.

(3) The heat-treated piece was quenched at 1050° C. for 1.5 h, tempered at 500° C. for 4 h and cooled to room temperature inside the furnace to obtain a forged piece, where the oil was used as the quenching medium.

(4) The forged piece was subjected to finishing machining to obtain a truncated cone-shaped die liner with a taper of 10°.

### Embodiment 5

A method of preparing an aluminum- and boron-containing die steel with resistance to zinc-induced hot corrosion for severe plastic deformation of zinc alloys includes the following steps.

(1) The raw material, including, in weight percentage, 0.2% C, 1.5% B, 1.5% W, 1.2% V, 1.65% Mo, 5.2% Cr, 0.7% Ti, 1.0% Si, 3.6% Al, and Fe for balance, was melted to 1560° C. and subjected to sand casting to obtain a cylindrical cast ingot, where a pouring temperature of the sand casting was 1460° C. The cylindrical cast ingot was cooled to room temperature by air cooling.

(2) The cast ingot was homogenized at 1050° C. for 4 h, hot-die forged at a temperature of 1100° C. with a forging ratio of 8 and a strain rate of 0.1 s⁻¹, and cooled to room temperature by air cooling to obtain a heat-treated piece.

(3) The heat-treated piece was quenched at 1050° C. for 1.5 h, tempered at 500° C. for 4 h and cooled to room temperature inside the furnace to obtain a forged piece, where the oil was used as the quenching medium.

(4) The forged piece was subjected to finishing machining to obtain a truncated cone-shaped die liner with a taper of 10°.

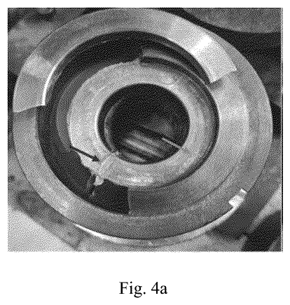

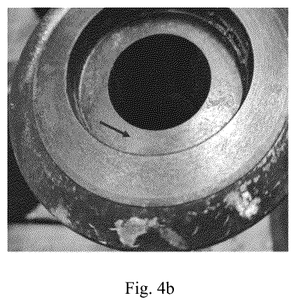

As shown in FIG. 4a, in the light-colored arrow, the surface of the die liner was covered with zinc. In the dark-colored arrow, H13 die steel liner had obvious zinc corrosion marks, and the crack was perpendicular to the die liner surface through the entire die. The outer edge of the die appeared to be thermal fatigue spalling. This was mainly because in the severe plastic deformation process of zinc alloy, the H13 die steel liner was together affected by the zinc adhesive corrosion and high temperature oxidation, resulting in the die liner surface embrittlement, which made it easier to stress corrosion and cracking under high stress, increasing the tendency of the die to fracture due to thermal fatigue in the service process. As shown in FIG. 4b, no obvious zinc fusion corrosion phenomenon appeared in the die steel prepared in this disclosure after long-term frequent service. These results indicated that the die steel prepared in this disclosure was difficult to adhere to the zinc alloy and had good anti-zinc fusion corrosion. Therefore, the die liner manufactured by the disclosure was not susceptible to stress corrosion in service and lead to liner cracking and failure.

The disclosure provides an alternative alloy to the H13 hot-working die steel. The die steel in the disclosure has good high-temperature mechanical properties, high-temperature fusion corrosion resistance, and low manufacturing cost. The disclosure simultaneously adds low carbon and high boron elements to form high hardness boride. The carbide is replaced with the boride with good high-temperature stability, high-temperature hardness, and zinc fusion corrosion resistance. Appropriate additions of alloying elements improve the hardenability of the matrix, toughness and high-temperature oxidation resistance. The morphology, size and distribution of boride hard phases are broken and regulated by hot forging, and low-carbon martensite and ferrite complex phase matrix with good toughness is obtained through heat treatment, thereby obtaining the high-aluminum boron-containing hot-working die steel with anti-zinc thermal fusion corrosion, which has good service safety and long service life under the severe plastic deformation service conditions of the zinc alloys.

In summary, the disclosure provides the high-aluminum boron-containing die steel with resistance to zinc-induced hot corrosion for severe plastic deformation of zinc alloys, and the preparation method thereof. Through forging work hardening, precipitation strengthening, boride morphology improvement and resistance to zinc-induced hot corrosion, the obtained die steel meets the long-time stable service requirements of the die for the zinc alloy severe plastic deformation under the severe service conditions such as high temperature, high load, and strong corrosion.

It should be noted that the above embodiments are only used to illustrate the technical solutions of the disclosure, and are not intended to limit the disclosure. It should be understood that any modifications and replacements made by those skilled in the art without departing from the spirit of the disclosure should fall within the scope of the disclosure defined by the appended claims.

What is claimed is:

1. A method of preparing an aluminum- and boron-containing die steel for severe plastic deformation of zinc alloys, comprising:
(S1) preparing a cast aluminum- and boron-containing die steel ingot through sand casting;
(S2) subjecting the cast aluminum- and boron-containing die steel ingot to homogenization, austenitization, hot-die forging and cooling to obtain a heat-treated piece;
(S3) subjecting the heat-treated piece to quenching and tempering to obtain a forged piece; and
(S4) performing finish machining on the forged piece to obtain the aluminum- and boron-containing die steel.

2. The method of claim 1, wherein in step (S1), the sand casting comprises a melting step at 1550-1600° C. and a pouring step at 1440-1480° C.

3. The method of claim 2, wherein the cast ingot is cylindrical.

4. The method of claim 1, wherein in step (S2), the hot-die forging is performed at a temperature of 980-1100° C., a forging ratio of 6-8 and a strain rate of 0.01-4 s⁻¹.

5. The method of claim 4, wherein in step (S2), the homogenization is performed at 1020-1080° C. for 3-5 h.

6. The method of claim 4, wherein in step (S2), the cooling is performed by air cooling.

7. The method of claim 1, wherein in step (S3), the quenching is performed at 1040-1080° C. for 1.5-2 h; and the tempering is performed at 480-530° C. for of 2.5-4.0 h.

8. The method of claim 7, wherein a quenching medium is oil; and after the tempering, the forged piece is cooled to room temperature by furnace cooling.

9. The method of claim 1, wherein in step (S4), the aluminum- and boron-containing die steel has a truncated cone structure with a taper of 9-11°.

10. An aluminum- and boron-containing die steel prepared by the method of claim 1, in weight percentage, comprising:
C: 0.15%-0.25%; B: 1.4%-1.8%; W: 1.4%-1.6%; V: 1.1%-1.3%; Mo: 1.55%-1.75%; Cr: 5.0%-5.5%; Ti: 0.6%-0.8%; Si: 0.4%-1.3%; Al: 2.4%-5.8%; and Fe: balance.
